(19) United States
(12) Patent Application Publication
(10) Pub. No.: US 2005/0081332 A1
(43) Pub. Date: Apr. 21, 2005

(54) Adjustable pin hinge

(75) Inventor: Gian Carlo Franchini, Correggio (IT)

Correspondence Address: PEARNE & GORDON LLP, 1801 EAST 9TH STREET, SUITE 1200, CLEVELAND, OH, 44114-3108, US

(73) Assignee: Elesa S.p.A., Milano (IT)

(21) Appl. No.: 10/950,137

(22) Filed: Sep. 24, 2004

(30) Foreign Application Priority Data
Oct. 16, 2003 (IT) MI002013/2003(U)

(51) Int. Cl. E05D 7/04

(52) U.S. Cl. 16/242

(57) ABSTRACT

An adjustable-pin hinge for mounting doors or hatches onto supporting doorframes. The hinge includes a first hinge element to be attached to the doorframe, a second hinge element to be attached to the door, and a pin to be assembled with the first and second hinge elements to allow mutual rotation thereof. The pin has first and second parts having spaced-apart parallel axes. The first part of the pin is cylindrical and allows free rotation of one of the first and second hinge elements. The second part of the pin includes a keying portion that may be keyed in a number of angular positions on the seat of the first hinge element.

### BACKGROUND OF THE INVENTION

The present invention relates to a pin hinge for the mounting of hatches and doors on supporting doorframes provided therefor, and more particularly to an adjustable pin hinge.

It is known that it is frequent for doors and hatches to be imperfectly mounted on their corresponding doorframes by means of hinges. Commonly, this is due to misalignment of the hinge pins onto which the doors are articulated, the correction of which normally requires long and annoying hinge adjustment operations.

Many attempts have been made to allow an easy and swift correction of such misalignments, and various types of hinges have been developed for this purpose. Such hinges presently available, however, are not satisfactory.

### BRIEF SUMMARY OF THE INVENTION

The present invention provides an adjustable-pin hinge for mounting doors or hatches onto supporting doorframes. The hinge comprises a first hinge element to be attached to the doorframe, the first hinge element comprising a seat; a second hinge element to be attached to the door; and a pin to be assembled with the first and second hinge elements to allow mutual rotation thereof.

The pin comprises first and second parts having spaced-apart parallel axes. The first part of the pin is cylindrical and allows free rotation of one of the first and second hinge elements. The second part of the pin comprises a keying portion that may be keyed in a plurality of angular positions on the seat of the first hinge element.

### BRIEF DESCRIPTION OF THE DRAWINGS

The invention will now be described in greater detail in the following, with reference to the attached drawings, which depict two present embodiments of the invention and which illustrate the adjustment of doors and hatches which may be achieved through the new hinge, wherein:

FIG. 1 is an axial section view of a hinge according to the invention with only partly-mounted in-line elements;

FIG. 2 is an external front view of the same hinge of FIG. 1, fully mounted;

FIG. 3 is a cross section along the line III-III of FIG. 1;

FIGS. 4 and 5 are perspective views with mounted and unmounted parts, respectively, of the hinge of FIGS. 1-3;

FIG. 6 shows how correction of the hinge misalignment of FIGS. 1-5 is carried out during mounting of a hatch;

FIG. 7 is a perspective view with mounted parts of an alternative embodiment of the hinge according to the invention, of the type having eccentric seats; and

FIG. 8 is a perspective view with unmounted parts of the alternative embodiment of the hinge according to the invention, of the type having eccentric seats.

### DETAILED DESCRIPTION OF THE INVENTION

With reference to FIGS. 1-8, the hinge according to the invention comprises a hinge element 1 to be attached to a doorframe (doorframe-mounted element), a hinge element 2 to be attached to a door or hatch (door-mounted element), and a pin 3 to be connected to said elements 1 and 2 to allow mutual rotation thereof, thereby allowing door or hatch pivoting.

The pin 3 consists of two substantially cylindrical parts 4 and 5, of a similar length and which, according to a first aspect of the invention, have respective parallel, but mutually spaced apart axes.

The first part 4 of the pin 3 allows free rotation of the hinge element 2, which hinge element 2 is mounted over said first part 4, thereby allowing free rotation of the door or hatch to which said hinge element 2 is attached.

The second part 5 of the pin 3 comprises instead a collar 6 with at least one non circular portion 7, which may be keyed on—in a plurality of angular positions—in a corresponding seat 8 of the hinge element 1 to be attached to the doorframe; in this way the pin 3 becomes integral with the element 1 and hence locked in rotation.

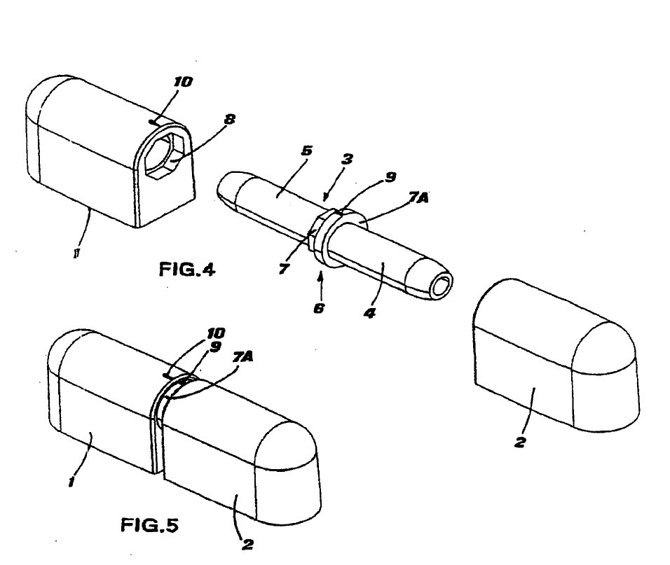

In the present embodiment illustrated in the drawings, portion 7 is in the shape of a right regular prism (an octagon in the illustration of FIG. 4) and may be inserted in the seat 8 which is of a shape matching portion 7, optionally in one of the angular locations possible, as many as the sides of said prism.

It is understood that other embodiments are possible. For example, portion 7 of the pin 3 might consist of a grooved profile or of a toothing, and the seat 8 of the hinge element 1 might be of a matching shape.

According to the present embodiment, the collar 6 of the pin 3 also comprises a cylindrical portion 7A, connected with the prism portion 7. This portion 7A represents a sort of washer which eases an even distribution of the load and which may further have a self-lubricating effect, provided the pin is made of suitable thermoplastic material. On the portion 7A a reference index 9 is further provided.

Since the pin 3 consists of two parts 4 and 5 having spaced-apart parallel-axes, between said axes there is determined a vertical plane which—in the angular position of the pin 3 is defined by the coincidence of an index 10 of the element 1 with an index 9 of the collar 7A—it substantially coincides with the plane of the door frame (drawing plane of FIG. 6 in the represented example). If both pins 3 of a door are in this angular position, the door rotation axis—coinciding with the axis going through the two parts 4 of the pins 3—finds itself on the same plane as the frame, but briefly spaced apart from the axis passing through parts 5 of the pins 3.

If parts 1 and 2 of the hinge have been perfectly mounted, the door rotation axis is perfectly vertical: door rotation is regular and the same remains stable in any position it is left in. If mounting was not perfect, the door rotation axis may be slightly oblique and door rotation is irregular (when the door is left in an intermediate position), it tends to spontaneously swing towards the open or closed position.

To overcome said mounting defect, it is thus possible, according to the invention, to lift pin 3 until the prism portion 7 thereof is removed out of the seat 8 thereof, to rotate it into a different angular position and to reposition the prism portion 7 in the seat 8. The choice of the angular position is aided by the visibility of index 9 which moves in respect of the index 10. It is evident that, as the part 5 of the pin 3 rotates about its own axis, in respect of the seat 1 thereof, the part 4 of the pin 3 in turn rotates and the axis thereof describes a circle about the axis of part 5; in this way, as can be understood, the distance measure between the two axes tends to cancel itself out in the cited door frame plane and at the same time it tends to increase in a plane perpendicular thereto. Given that, for the purpose of door rotation uniformity, mainly the distance measure in said door frame plane is of interest—which measure indicates the distance between the doorframe and the door or hatch—it is clear that with such rotation it is possible to adjust mounting as appropriate.

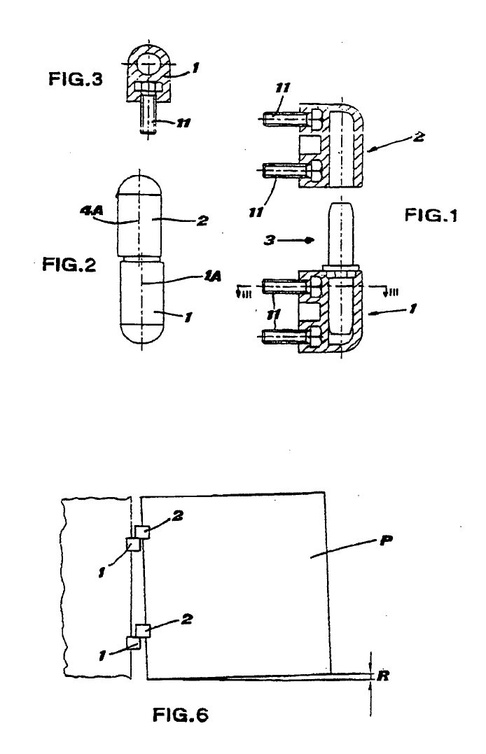

FIG. 2 of the accompanying drawings clearly shows the case in which the pin 3 of the hinge according to the invention has been arranged so that the axis 4A of its cylindrical part 4 is non aligned in respect to the axis 1A of the element 1 of the hinge, in respect of the door frame plane (plane perpendicular to the drawing plane).

By adjusting in a different way the non-alignment between axes 1A and 4A of the two hinges of a door, it is thus possible to correct the position of the rotation axis of the door in respect to the doorframe.

FIG. 6 represents a highly-exaggerated incorrect mounting condition which, as already mentioned above, may be very simply corrected in the following manner: remove the door, remove pin 3 from seat 8 of element 1, rotate said pin by one or more positions of its own prism portion 7, reintroduce it into seat 8; thereafter, the hinge element 2 of the door is again inserted over the pin 3. Then, a door alignment and rotation check is performed again to verify if a further adjustment is necessary (in which case the above described operations should be repeated). In FIG. 6, the reference R refers to the maximum obtainable correction of the hinge misalignment.

The hinge according to the invention of FIGS. 1 to 6 is of the type having elements 1 and 2 in line, of a simple and closed shape, which are provided, for the attachment thereof, with threaded screw inserts 11, but threaded nut inserts can equally be used.

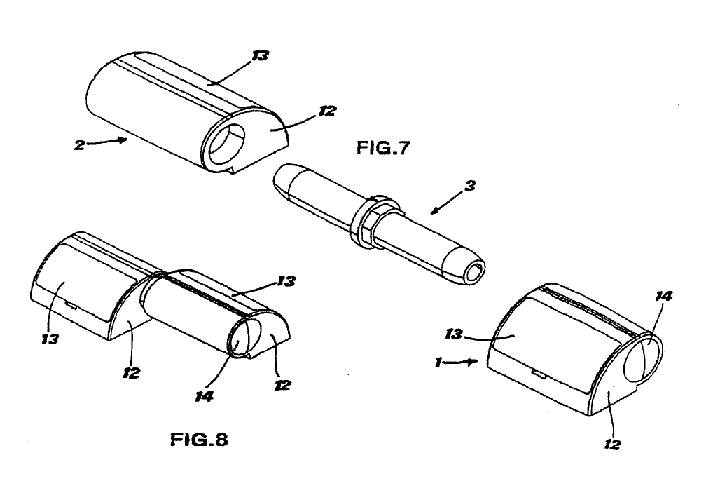

FIGS. 7 and 8 in turn represent a hinge according to the invention having elements 1 and 2 of a more elaborate shape, with the seats for the parts 4, 5 of the pin 3 arranged eccentrically in respect to the bodies 12, these further having wing-shaped portions with seats (not shown) for the attachment screws or nuts; such different seats are closed on the one hand by covers 13 and on the other hand by a plug 14 for pin 3. Said covers and plugs protect the attachment area of elements 1 and 2 of the hinge and the rotation pin 3, as well as the seat therefore, against dust and environmental agents.

According to the invention, the adjustment features of the hinge of FIGS. 6 and 7 are substantially the same as those of the hinge depicted in FIGS. 1 to 5. Thus, adjustment is performed in the same way and will not be repeated herein.

The hinge according to the invention may be manufactured using a variety of materials. According to the present embodiment, the hinged is manufactured using thermoplastic material.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. An adjustable-pin hinge for mounting doors or hatches onto supporting doorframes, the hinge comprising:
a first hinge element (1) for attachment to the doorframe, the first hinge element comprising a seat (8);
a second hinge element (2) for attachment to the door or hatch; and
a pin (3) to be assembled with the first and second hinge elements (1 and 2) to allow mutual rotation thereof, the pin (3) comprising first and second parts (4 and 5) having spaced-apart parallel axes, wherein the first part (4) of the pin is cylindrical and allows free rotation of one of the first and second hinge elements (1, 2), and wherein the second part (5) of the pin comprises a keying portion (7) that maybe keyed in a plurality of angular positions on the seat (8) of the first hinge element (1).

2. The adjustable-pin hinge of claim 1, wherein the pin (3) further comprises a first reference index (9) and the first hinge element (1) further comprises a second reference index (10), and wherein the first and second indexes (9, 10) are provided for grading an adjustment of the hinge.

3. The adjustable-pin hinge of claim 1, wherein the keying portion (7) of the pin (3) comprises a right regular prism, and wherein the seat (8) comprises a correspondingly shaped part.

4. The adjustable-pin hinge of claims 1, wherein the pin (3) comprises a central collar (6) having first and second portions (7, 7A), wherein the first portion (7, 7A) of the central collar defines the keying portion (7), wherein the keying portion (7) may be removed from and selectively inserted into the seat (8) in one of the angular positions to become integral with the first hinge element (1), the second portion of the central collar being a cylindrical portion (7A) including the first reference index (9).

5. The adjustable-pin hinge of claim 1, wherein the first and second hinge elements are in-line elements.

6. The adjustable-pin hinge of claim 5, wherein the first and second hinge elements are each adapted to receive a threaded fastener for attachment to the door or hatch and the doorframe.

7. The adjustable-pin hinge of claim 1, wherein the first and second hinge elements have eccentric seats.

8. The adjustable-pin hinge of claim 7, wherein the first and second hinge elements are adapted to receive threaded fasteners for attachment to the door or hatch and the doorframe, and are arranged within compartments provided with covers (13).

9. The adjustable-pin hinge of claim 7, further comprising protecting covers (14) for the pin (3) provided on the eccentric seats of the first and second hinge elements.

10. The adjustable-pin hinge of claim 1, wherein at least one of the first and second hinge elements and the pin are made of thermoplastic material.
